(19) United States
(12) Patent Application Publication
(10) Pub. No.: US 2026/0094735 A1
(43) Pub. Date: Apr. 2, 2026

(54) MAGNESIA CEMENT FOR THE SOLIDIFICATION OF AQUEOUS WASTE

(71) Applicant: BATTELLE SAVANNAH RIVER ALLIANCE, LLC, AIKEN, SC (US)

(72) Inventor: WILLIAM C. JOLIN, EVANS, GA (US)

(21) Appl. No.: 18/901,685

(22) Filed: Sep. 30, 2024

(51) Int. Cl. G21F 9/30; C04B 9/00; C04B 22/08; C04B 22/14; C04B 111/00

(52) U.S. Cl. CPC G21F 9/304; C04B 9/00; C04B 22/085; C04B 22/142; C04B 2111/00767

(57) ABSTRACT

The present invention is directed to a solidified composition and a method of making such solidified composition. The solidified composition may have a lower leachate pH when compared to ordinary Portland cement. The solidified composition may be formed from a slurry comprising magnesium oxide, a salt, and water. Notably, the solidified composition may further comprise one or more actinides. The methods of the present invention are directed to making the aforementioned solidified compositions.

### FEDERAL RESEARCH STATEMENT

This invention was made with government support under Contract No. 89303321CEM000080 awarded by the U.S. Department of Energy. The government has certain rights in the invention.

### BACKGROUND OF THE INVENTION

Traditionally, aqueous waste streams, such as those containing hazardous and/or radioactive components, have been stored in storage tanks and evaporation ponds. However, these waste management methods may have various drawbacks. For instance, storage tanks may be susceptible to corrosion, stress cracking, and or degradation. Further, for instance, evaporation ponds generally utilize a significant amount of land and may even subject soil and/or groundwater to contamination.

Consequently, in recent times, the solidification of aqueous waste streams has become a viable system for waste management. Indeed, the solidification of aqueous waste streams containing hazardous and/or radioactive components into a cement may be particularly advantageous. However, the type and amounts of additives utilized to solidify aqueous waste streams are exceptionally wide-ranging. As such, it remains to be ascertained which types and amounts of additives may be beneficial in solidifying aqueous waste streams. Further, the properties and characteristics of the solidified waste are notably important because they affect the handling and storage of the solidified waste.

As a result, there is a need to provide an improved solidified waste. In particular, a need exists for providing a solidified waste from an aqueous waste stream, the solidified waste having improved properties and characteristics.

### SUMMARY OF THE INVENTION

Aspects and advantages of the invention will be set forth in part in the following description, or may be obvious from the description, or may be learned through practice of the invention.

In accordance with one aspect of the present invention, a solidified composition is disclosed. The solidified composition may comprise magnesium oxide; and a salt; wherein the solidified composition is formed from a slurry, the slurry comprising a first solution, the first solution comprising water, the first solution further comprising one or more actinides, one or more nitrate salts, or both.

In accordance with another aspect of the present invention, a solidified composition is disclosed. The solidified composition may comprise magnesium oxide, wherein the solidified composition is formed from a slurry, the slurry comprising: magnesium oxide, the magnesium oxide being present in the slurry in an amount of about 5 wt. % or more; a salt, the salt being present in the slurry in an amount of about 1 wt. % or more; and water, the water being present in the slurry in an amount of about 10 wt. % or more; wherein the solidified composition has a leachate pH from about 7 to about 11.

In accordance with a further aspect of the present invention, a solidified composition is disclosed. The solidified composition may comprise magnesium oxide, wherein the solidified composition is formed from a slurry, the slurry comprising: light burned magnesium oxide; and dead burned magnesium oxide, the light burned magnesium oxide and the dead burned magnesium oxide being present in the slurry in a weight ratio from about 1:20 to about 10:1; wherein the solidified composition comprises magnesium hydroxide and has a density greater than about 0.5 g/mL.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a solidified composition in accordance with aspects of the present subject matter.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a solidified composition and a method of making such solidified composition. In particular, the solidified composition may be formed from a slurry comprising magnesium oxide, a salt, and one or more optional additives. The present inventors have discovered that the solidified composition disclosed herein can have various benefits due to the use of magnesium oxide, one or more salts, and one or more optional additives. Particularly, the present inventors have discovered that the slurry and/or solidified composition, which may be a magnesia cement, may have enhanced leachate pH, flowability, mixability, density, or a combination thereof. Notably, the solidified composition may be particularly applicable for storing nitrate salts, which may be used in nuclear fuel reprocessing, and actinides, such as plutonium and/or americium.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present disclosure may omit one or more of the features disclosed herein.

In general, a solidified composition may be formed at least partially by the reaction of magnesium oxide, a salt, and water. For instance, the chemical reaction between magnesium oxide, a salt, and water may be:

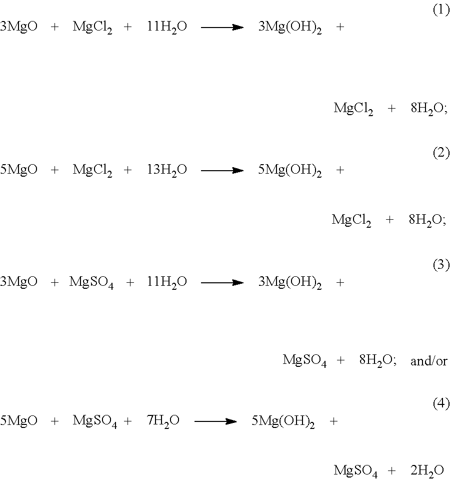

Notably, the above reactions may at least partially result in the solidification of a slurry to form a solidified composition in accordance with the present disclosure.

Generally, a solidified composition may be formed by a slurry comprising a first solution. The first solution may include nitrate salts, one or more actinides (e.g., plutonium, americium), and water. Particularly, the first solution may be a waste solution resulting from the processing of nuclear fuel. In some aspects, the first solution may be acidic. In general, the first solution may be combined and mixed with magnesium oxide, a salt, and one or more optional additives to form a slurry that sets to form a solidified composition.

Notably, the first solution may be present in the slurry in an amount from about 0.01 wt. % to about 70 wt. %, including all increments of 0.01 wt. % therebetween. Generally, the first solution may be present in the slurry in an amount of about 0.01 wt. % or more, such as about 10 wt. % or more, such as about 20 wt. % or more, such as about 30 wt. % or more, such as about 40 wt. % or more, such as about 50 wt. % or more, such as about 60 wt. % or more. In general, the first solution may be present in the slurry in an amount of about 70 wt. % or less, such as about 60 wt. % or less, such as about 50 wt. % or less, such as about 40 wt. % or less, such as about 30 wt. % or less, such as about 20 wt. % or less, such as about 10 wt. % or less.

In general, water may be present in the slurry in an amount from about 10 wt. % to about 70 wt. %, including all increments of 0.01 wt. % therebetween. For instance, water may be present in the slurry in an amount of about 10 wt. % or more, such as about 20 wt. % or more, such as about 30 wt. % or more, such as about 40 wt. % or more, such as about 50 wt. % or more, such as about 60 wt. % or more. In general, water may be present in the slurry in an amount of about 70 wt. % or less, such as about 60 wt. % or less, such as about 50 wt. % or less, such as about 40 wt. % or less, such as about 30 wt. % or less, such as about 20 wt. % or less, such as about 10 wt. % or less.

In some aspects, nitrate salts may be present in the slurry in an amount from about 0.01 wt. % to about 30 wt. %, including all increments of 0.01 wt. % therebetween. Generally, nitrate salts may be present in the slurry in an amount of about 0.01 wt. % or more, such as about 5 wt. % or more, such as about 10 wt. % or more, such as about 15 wt. % or more, such as about 20 wt. % or more, such as about 25 wt. % or more. In general, nitrate salts may be present in the slurry in an amount of about 30 wt. % or less, such as about 25 wt. % or less, such as about 20 wt. % or less, such as about 15 wt. % or less, such as about 10 wt. % or less, such as about 5 wt. % or less.

As previously disclosed herein, the solidified composition may be formed from a slurry including magnesium oxide. For instance, a solidified composition may be formed from a slurry including light burned magnesium oxide and/or dead burned magnesium oxide. As used herein, “light burned magnesium oxide” refers to magnesium oxide obtained by heating or firing a precursor (e.g., magnesium carbonate, magnesium hydroxide) at a temperature from about 700° C. to about 1000° C. Notably, light burned magnesium oxide may be made as a slightly less reactive material through changes in initial material or slight changes in the firing process. As used herein, “dead burned magnesium oxide” refers to magnesium oxide obtained by heating or firing a precursor (e.g., magnesium carbonate, magnesium hydroxide) at a temperature from about 1500° C. to about 2000° C.

Notably, magnesium oxide may be present in a slurry in an amount from about 0.01 wt. % to about 70 wt. %, including all increments of 0.01 wt. % therebetween. Generally, magnesium oxide may be present in a slurry that forms the solidified composition in an amount of about 0.01 wt. % or more, such as about 1 wt. % or more, such as about 5 wt. % or more, such as about 10 wt. % or more, such as about 20 wt. % or more, such as about 30 wt. % or more, such as about 40 wt. % or more, such as about 50 wt. % or more, such as about 60 wt. % or more. In general, magnesium oxide may be present in a slurry that forms the solidified composition in an amount of about 70 wt. % or less, such as about 60 wt. % or less, such as about 50 wt. % or less, such as about 40 wt. % or less, such as about 30 wt. % or less, such as about 20 wt. % or less, such as about 10 wt. % or less, such as about 5 wt. % or less.

Generally, light burned magnesium oxide may be present in a slurry that forms the solidified composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more. In general, light burned magnesium oxide may be present in a slurry that forms the solidified composition in an amount of about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less.

Generally, dead burned magnesium oxide may be present in a slurry that forms the solidified composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more. In general, dead burned magnesium oxide may be present in a slurry that forms the solidified composition in an amount of about 60 wt. % or less, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less.

In some aspects, the weight ratio of light burned magnesium oxide to dead burned magnesium oxide in the slurry may be from about 1:20 to about 10:1, including all increments ratios therebetween. For instance, the weight ratio of light burned magnesium oxide to dead burned magnesium oxide in the slurry may be about 1:20 or more, such as about 1:10 or more, such as about 1:5 or more, such as about 1:4 or more, such as about 1:3 or more, such as about 1:2 or more, such as about 1:1 or more, such as about 2:1 or more, such as about 5:1 or more. In general, the weight ratio of light burned magnesium oxide to dead burned magnesium oxide in the slurry may be about 10:1 or less, such as about 5:1 or less, such as about 2:1 or less, such as about 1:1 or less, such as about 1:2 or less, such as about 1:3 or less, such as about 1:4 or less, such as about 1:5 or less, such as about 1:10 or less. Notably, in some aspects, the amount by weight of dead burned magnesium oxide in the slurry may be greater than the amount by weight of light burned magnesium oxide in the slurry.

As previously disclosed herein, the solidified composition may be formed from a slurry including one or more salts. For instance, a solidified composition may be formed from a slurry including a sulfate salt and/or a chloride salt. In some aspects, a solidified composition may be formed from a slurry including an alkali salt and/or an alkaline earth salt. Notably, an alkali salt may include any of the alkali metals (e.g., sodium, potassium) and an alkaline earth salt may include any of the alkaline earth metals (e.g., magnesium). In general, the one or more salts may include magnesium sulfate, potassium sulfate, sodium sulfate, magnesium chloride, potassium chloride, sodium chloride, or a combination thereof.

Notably, a slurry may include a sulfate salt (e.g., magnesium sulfate) and/or a chloride salt in an amount from about 0.01 wt. % to about 30 wt. %, including all increments of 0.01 wt. % therebetween. In general, a slurry may include a sulfate salt and/or a chloride salt in an amount of about 0.01 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 12 wt. % or more, such as about 15 wt. % or more, such as about 18 wt. % or more, such as about 20 wt. % or more, such as about 25 wt. % or more. Generally, a slurry may include a sulfate salt and/or a chloride salt in an amount of about 30 wt. % or less, such as about 25 wt. % or less, such as about 20 wt. % or less, such as about 18 wt. % or less, such as about 15 wt. % or less, such as about 12 wt. % or less, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less, such as about 1 wt. % or less.

In some aspects, a slurry may include an alkali salt and/or an alkaline earth salt (e.g., magnesium sulfate) in an amount from about 0.01 wt. % to about 30 wt. %, including all increments of 0.01 wt. % therebetween. In general, a slurry may include an alkali salt and/or an alkaline earth salt in an amount of about 0.01 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 12 wt. % or more, such as about 15 wt. % or more, such as about 18 wt. % or more, such as about 20 wt. % or more, such as about 25 wt. % or more. Generally, a slurry may include an alkali salt and/or an alkaline earth salt in an amount of about 30 wt. % or less, such as about 25 wt. % or less, such as about 20 wt. % or less, such as about 18 wt. % or less, such as about 15 wt. % or less, such as about 12 wt. % or less, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less, such as about 1 wt. % or less.

As previously disclosed herein, a slurry may include one or more additives. Notably, an additive may be a heat sink additive, which reduces the heat of hydration generated during a reaction of magnesium oxide, a salt, and water. For instance, a heat sink additive may include sand, fly ash, zirconium oxide, or a combination thereof. Generally, an additive may be non-reactive with one or more components of the slurry. Additionally, an additive may enhance the mixability and/or density of the slurry. Generally, the slurry may include additives such as sand, silica fume, metakaolin, Portland cement, zirconium oxide, iron, slag, fly ash, or a combination thereof. Notably one or more of these additives may be present in a slurry in an amount from about 0.01 wt. % to about 70 wt. %, including all increments of 0.01 wt. % therebetween. Generally, one or more of the aforementioned additives (e.g., a heat sink additive) may be present in a slurry that forms the solidified composition in an amount of about 0.01 wt. % or more, such as about 1 wt. % or more, such as about 5 wt. % or more, such as about 10 wt. % or more, such as about 20 wt. % or more, such as about 30 wt. % or more, such as about 40 wt. % or more, such as about 50 wt. % or more, such as about 60 wt. % or more. In general, one or more of the aforementioned additives (e.g., a heat sink additive) may be present in a slurry that forms the solidified composition in an amount of about 70 wt. % or less, such as about 60 wt. % or less, such as about 50 wt. % or less, such as about 40 wt. % or less, such as about 30 wt. % or less, such as about 20 wt. % or less, such as about 10 wt. % or less, such as about 5 wt. % or less.

Generally, the solidified composition may include magnesium hydroxide, magnesium oxide, water, one or more nitrate salts, one or more actinides, quartz, gypsum, a sulfate salt, a chloride salt, an alkali salt, an alkaline earth salt, or a combination thereof. Notably, the magnesium oxide of the solidified composition may include unreacted magnesium oxide from the slurry that forms the solidified composition. Further, the sulfate salt, chloride salt, alkali salt, and/or alkaline earth salt may be any of the sulfate salts, chloride salts, alkali salts, and/or alkaline earth salts previously disclosed herein.

The solidified composition of the present disclosure may advantageously have a lower leachate pH than other traditional solidified compositions, and more particularly may have a lower leachate pH than a solidified composition that is primarily Portland cement. Generally, the leachate pH of Portland cement is about 13. A lower leachate pH may be advantageous in that it may lower the corrosion of the container in which the solidified composition is contained. Further, a lower leachate pH may be advantageous in that it may have a lower environmental impact than higher pH compositions. Additionally, a lower leachate pH may be advantageous in that it poses lower health risks to operators working with the slurry, the solidified composition, and the container in which the solidified composition may be contained. Further, a lower leachate pH may be advantageous in that it may reduce or delay the degradation of the solidified composition itself.

Notably, a solidified composition formed in accordance with the present disclosure may have a leachate pH from about 5 to about 12, such as a pH of about 5 or more, such as a pH of about 6 or more, such as a pH of about 7 or more, such as a pH of about 8 or more, such as a pH of about 9 or more, such as a pH of about 10 or more, such as a pH of about 11 or more. In general, a solidified composition formed in accordance with the present disclosure may have a leachate pH of about 12 or less, such as a pH of about 11 or less, such as a pH of about 10 or less, such as a pH of about 9 or less, such as a pH of about 8 or less, such as a pH of about 7 or less. The leachate pH of a solidified composition may be tested by adding a portion of crushed solidified composition into a container (e.g., centrifuge) and adding a volume of deionized water or sodium chloride to the container. The solidified composition and the volume of deionized water or sodium chloride may then be mixed and the leachate pH may be determined with a pH meter, such as an Accumet AB150 PH meter with a Fisher Scientific Model 13-620-19 temperature probe.

In one aspect, the leachate pH of a solidified composition sample may be determined by crushing and sieving a portion of the solidified composition such that 20 grams of the solidified composition pass through a sieve (e.g., a ⅜″ sieve). Then, for each solidified composition sample, the 20 grams of crushed and sieved solidified composition may be placed in a centrifuge tube and 20 ml of either deionized water or 5 M sodium chloride may be added to the centrifuge tube. The centrifuge tubes may then be placed on a rotatory mixer and rotated for a period of seven days. The pH of the solution may be determined by centrifuging a sample and removing a small aliquot at 1 day, 3 days, and 7 days respectively. The pH of this aliquot may then be measured using an Accumet AB150 PH meter with a Fisher Scientific Model 13-620-19 temperature probe. The average of the recorded pH values may be utilized as the leachate pH value.

In some aspects, the slurry or solidified composition of the present disclosure may have a density of about 0.5 g/mL or more, such as about 1 g/mL or more, such as about 1.5 g/mL or more, such as about 2 g/mL or more. In general, the slurry or solidified composition of the present disclosure may have a density of about 5 g/mL or less, such as about 4 g/mL or less, such as about 3 g/mL or less, such as about 2.5 g/mL or less, such as about 2 g/mL or less, such as about 1.5 g/mL or less. Notably, the density may be determined in accordance with ASTM C271.

In some aspects, the slurry or solidified composition may have a set time of 15 minutes or more, such as 30 minutes or more, such as 1 hour or more, such as 2 hours or more, such as 3 hours or more, such as four 4 or more, such as 12 hours or more. In general, the slurry or solidified composition may have a set time of 48 hours or less, such as 24 hours or less, such as 12 hours or less, such as 4 hours or less. The set time of the slurry or solidified composition sample may be determined in accordance with ASTM C807-08.

Generally, the slurry may be formed by combining and mixing one or more of any of the additives disclosed here. For instance, the slurry may be formed by combining and mixing water, a first solution (e.g., a waste solution), magnesium oxide, a salt (e.g., magnesium sulfate), and one or more optional additives, such as any of the additives disclosed herein in any amounts disclosed herein. In general, the first solution (e.g., a waste solution), magnesium oxide, salt (e.g., magnesium sulfate), and one or more optional additives may be added to the slurry before, after, and/or during the addition of any of the aforementioned additives to the slurry. Generally, the slurry may be mixed in a container, such as a drum (e.g., steel drum). The slurry may be mixed in a container before, during, and/or after the addition of one or more additives disclosed herein. Notably, the first solution may be added to a container, which has a mixer positioned therein or is a mixer. Then, the first solution may be mixed in the container. Next, magnesium oxide may be added to the container. Then, a salt (e.g., magnesium sulfate) may be added to the container. Next, one or more optional additives (e.g., sand) may be added to the container. Then, the material may set as a result of the reactions between the components, more particularly between the magnesium oxide and the salt. It should be understood that the components of the slurry may be mixed at any point in the process, such as throughout the entirety of the process beginning after the first solution is added to the container.

After the slurry solidifies in the container, the container may be moved to a repository, such as a second container. In this respect, the solidified composition may be stored in a container, which may be later stored in a repository.

### EXAMPLES

### Test Methods

Leachate pH Test: The leachate pH of each solidified composition sample was determined by removing an individual replicate of the solidified composition at various periods of cure time (e.g., 7 day cure time, 28 day cure time, 8 week cure time, 12 week cure time, 16 week cure time). Then, a portion of the replicate of the solidified composition was crushed and sieved with a ⅜″ sieve to form four samples. Each sample was 20 grams of the crushed and sieved solidified composition. Then, for each solidified composition sample, the 20 grams of crushed and sieved solidified composition was placed in a centrifuge tube and 20 mL of either deionized water or 5 M sodium chloride was added to the centrifuge tube in duplicate for each solution. Notably, two samples had 20 mL of deionized water added to the respective samples and the other two samples had 20 mL of 5 M sodium chloride added to the respective samples. The centrifuge tubes were then placed on a rotatory mixer and rotated for a period of seven days. The pH of each solution was determined by centrifuging each sample and removing a small aliquot at 1 day, 3 days, and 7 days respectively. The pH of this aliquot was measured using an Accumet AB150 PH meter with a Fisher Scientific Model 13-620-19 temperature probe. The average of the six recorded pH values for each sample was calculated and recorded. In this respect, the six values of the two samples having 20 mL of deionized water added to the respective samples were averaged and recorded and the six values of the two samples having 20 mL of 5 M sodium chloride added to the respective samples were averaged and recorded. The aliquot was discarded after the pH was measured.

Set Time Test: The set time of each solidified composition sample was determined in accordance with ASTM C807-08 via Vicat Needle. Notably, if the needle penetrated the solidifying slurry more than 2 mm, the solidifying slurry was considered not set. The mixture was tested periodically until the needle did not penetrate the solidifying slurry more than 2 mm.

### Example 1

Solidified compositions were formed in accordance with the present disclosure. Each solidified composition sample was formed with 1 kilogram of solid material comprising a light burned magnesium oxide composition or a dead burned magnesium oxide composition, magnesium sulfate, and sand. After combining the light burned magnesium oxide composition or a dead burned magnesium oxide composition, magnesium sulfate, and sand, the components were mixed to form a visually homogenous mixture. Next, 0.35 kg of a first solution comprising 4 M sodium nitrate in deionized water was added to the mixture to form a slurry. The slurry was then mixed for the mixing times illustrated in Table 2. The respective mixing times, set times, leachate pH, and densities are listed in Table 2. Notably, the leachate pH values were determined in accordance with the aforementioned leachate pH test. The leachate pH was tested after various periods of time in which the solidified composition was allowed to cure. The set times were determined in accordance with the aforementioned set time test. The densities were determined in accordance with ASTM C271.

Notably, light burned magnesium oxide compositions 1-3 and dead burned magnesium composition 1 were tested via inductively coupled plasma atomic emission spectroscopy (ICP-AES), the results of which are disclosed in Table 1. Light burned magnesium oxide composition 2 was made as a slightly less reactive material than light burned magnesium oxide compositions 1 and 3 through changes in initial material or slight changes in the firing process. Notably, the total amount in wt. % in Table 1 does not equal 100 because the compositions contained components not specifically tested for.

TABLE 1

| | Amount | Amount | Amount | Amount | Amount | Amount | Amount | Amount | Amount |
|---|---|---|---|---|---|---|---|---|---|
| | of Al₂O₃ | of CaO | of Fe₂O₃ | of K₂O | of MgO | of Na₂O | of SO₄ | of SiO₂ | of Ti₂O |
| Composition | [wt. %] | [wt. %] | [wt. %] | [wt. %] | [wt. %] | [wt. %] | [wt. %] | [wt. %] | [wt. %] |
| Light Burned | 0.75 | 7.64 | 0.78 | <0.120 | 82.25 | <0.135 | 0.56 | 3.36 | <0.167 |
| Magnesium Oxide | | | | | | | | | |
| Composition 1 | | | | | | | | | |
| Light Burned | 0.64 | 2.16 | 0.34 | <0.121 | 80.43 | <0.135 | <0.300 | 6.43 | <0.167 |
| Magnesium Oxide | | | | | | | | | |
| Composition 2 | | | | | | | | | |
| Light Burned | <0.189 | 1.35 | 0.38 | <0.120 | 90.71 | <0.135 | <0.300 | 0.66 | <0.167 |
| Magnesium Oxide | | | | | | | | | |
| Composition 3 | | | | | | | | | |
| Dead Burned | 0.80 | 1.53 | 2.82 | <0.122 | 87.06 | <0.135 | <0.300 | 3.66 | <0.167 |
| Magnesium Oxide | | | | | | | | | |
| Composition 1 | | | | | | | | | |

TABLE 2

| | | | | | Leachate pH | | | | | | | | |
|---|---|---|---|---|---|---|---|---|---|---|---|---|---|
| | | | | | 7 Day Cure | | 28 Day Cure | | 8 Week Cure | | 16 Week Cure | | |
| | Weight Percentage | Waste | Mixing | | DI | 5M | DI | 5M | DI | 5M | DI | 5M | |
| Sample | of Components | Loading | Time | Set | Water | NaCl | Water | NaCl | Water | NaCl | Water | NaCl | Density |
| Number | [wt. %] | [wt. %] | [min:sec) | Time | [pH] | [pH] | [pH] | [pH] | [pH] | [pH] | [pH] | [pH] | [g/mL] |
| 1 | 30 wt. % Light Burned | 0.35 | 1:54 | 2 | 9.4 ± | 8.7 ± | 9.4 ± | 8.7 ± | | | 9.4 ± | 8.8 ± | 2.0 ± |
| | Magnesium Oxide | | | hours | 0.1 | 0.0 | 0.1 | 0.1 | | | 0.0 | 0.0 | 0.1 |
| | Composition 1 | | | | | | | | | | | | |
| | 10 wt. % Magnesium sulfate | | | | | | | | | | | | |
| | 60 wt. % Sand | | | | | | | | | | | | |
| 2 | 15 wt. % Light Burned | 0.35 | 0:20 | 24 | 9.4 ± | 8.8 ± | 9.4 ± | 8.7 ± | | | 9.4 ± | 8.9 ± | 2.0 ± |
| | Magnesium Oxide | | | hours | 0.2 | 0.2 | 0.1 | 0.1 | | | 0.0 | 0.0 | 0.1 |
| | Composition 1 | | | | | | | | | | | | |
| | 5 wt. % Magnesium sulfate | | | | | | | | | | | | |
| | 80 wt. % Sand | | | | | | | | | | | | |
| 3 | 45 wt. % Light Burned | 0.35 | 2:00 | 4 | 9.2 ± | 8.5 ± | | | 9.2 ± | 8.5 ± | | | 2.1 ± |
| | Magnesium Oxide | | | hours | 0.0 | 0.0 | | | 0.0 | 0.0 | | | 0.1 |
| | Composition 2 | | | | | | | | | | | | |
| | 15 wt. % Magnesium sulfate | | | | | | | | | | | | |
| | 40 wt. % Sand | | | | | | | | | | | | |
| 4 | 30 wt. % Light Burned | 0.35 | 2:00 | 4 | 9.3 ± | 8.6 ± | | | 9.2 ± | 8.5 ± | | | 2.1 ± |
| | Magnesium Oxide | | | hours | 0.0 | 0.0 | | | 0.0 | 0.0 | | | 0.1 |
| | Composition 2 | | | | | | | | | | | | |
| | 10 wt. % Magnesium sulfate | | | | | | | | | | | | |
| | 60 wt. % Sand | | | | | | | | | | | | |
| 5 | 30 wt. % Light Burned | 0.35 | 2:00 | 0.5 | 9.4 ± | 8.7 ± | | | 9.3 ± | 8.6 ± | | | 2.1 ± |
| | Magnesium Oxide | | | hours | 0.1 | 0.0 | | | 0.1 | 0.0 | | | 0.1 |
| | Composition 3 | | | | | | | | | | | | |
| | 10 wt. % Magnesium sulfate | | | | | | | | | | | | |
| | 60 wt. % Sand | | | | | | | | | | | | |
| 6 | 80 wt. % Dead Burned | 0.35 | 2:00 | 3 | 9.3 ± | 8.5 ± | | | 9.2 ± | 8.5 ± | | | 2.1 ± |
| | Magnesium Oxide | | | hours | 0.0 | 0.0 | | | 0.0 | 0.0 | | | 0.1 |
| | Composition 1 | | | | | | | | | | | | |
| | 20 wt. % Magnesium sulfate | | | | | | | | | | | | |

### Example 2

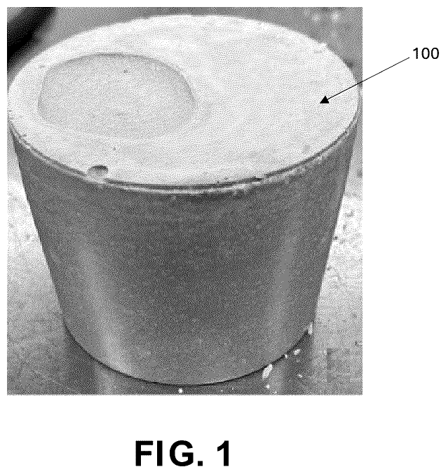

Solidified compositions were formed in accordance with the present disclosure. Each solidified composition sample was formed with 1 kilogram of solid material comprising a light burned magnesium oxide composition, magnesium sulfate, and sand. After combining the light burned magnesium oxide composition, magnesium sulfate, and sand, the components were mixed to form a visually homogenous mixture. Next, 0.5 kg of a first solution comprising 4 M sodium nitrate in deionized water was added to the mixture to form a slurry. The slurry was then mixed for the mixing times illustrated in Table 3. The respective mixing times, set times, leachate pH, and densities are listed in Table 3. Notably, the leachate pH values were determined in accordance with the aforementioned leachate pH test. The leachate pH was tested after various periods of time in which the solidified composition was allowed to cure. The set times were determined in accordance with the aforementioned set time test. The densities were determined in accordance with ASTM C271. Notably, FIG. 1 illustrates the solidified composition 100 of Sample Number 7.

Notably, light burned magnesium oxide compositions 1-3 were tested via inductively coupled plasma atomic emission spectroscopy (ICP-AES), the results of which are disclosed in Table 1. Light burned magnesium oxide composition 2 was made as a slightly less reactive material than light burned magnesium oxide compositions 1 and 3 through changes in initial material or slight changes in the firing process. Notably, the total amount in wt. % in Table 1 does not equal 100 because the compositions contained components not specifically tested for.

TABLE 3

| | | | | | Leachate pH | | | | | | |
|---|---|---|---|---|---|---|---|---|---|---|---|
| | | | | | 7 Day Cure | | 28 Day Cure | | 12 Week Cure | | |
| | Weight Percentage | Waste | Mixing | | DI | 5M | DI | 5M | DI | 5M | |
| Sample | of Components | Loading | Time | Set | Water | NaCl | Water | NaCl | Water | NaCl | Density |
| Number | [wt. %] | [wt. %] | [min:sec) | Time | [pH] | [pH] | [pH] | [pH] | [pH] | [pH] | [g/mL] |
| 7 | 30 wt. % Light Burned | 0.50 | 2:00 | 3 | 9.3 ± | 8.7 ± | 9.4 ± | 8.7 ± | 9.4 ± | 8.9 ± | 2.0 ± |
| | Magnesium Oxide | | | hours | 0.1 | 0.1 | 0.1 | 0.0 | 0.1 | 0.1 | 0.0 |
| | Composition 1 | | | | | | | | | | |
| | 10 wt. % Magnesium sulfate | | | | | | | | | | |
| | 60 wt. % Sand | | | | | | | | | | |
| 8 | 30 wt. % Light Burned | 0.50 | 2:00 | 3 | 9.2 ± | 8.6 ± | 9.3 ± | 8.7 ± | 9.3 ± | 8.7 ± | 1.9 ± |
| | Magnesium Oxide | | | hours | 0.1 | 0.1 | 0.0 | 0.0 | 0.1 | 0.1 | 0.1 |
| | Composition 3 | | | | | | | | | | |
| | 10 wt. % Magnesium sulfate | | | | | | | | | | |
| | 60 wt. % Sand | | | | | | | | | | |
| 9 | 30 wt. % Light Burned | 0.50 | 2:00 | 24 | 9.2 ± | 8.6 ± | 9.3 ± | 8.7 ± | 9.4 ± | 8.7 ± | 1.9 ± |
| | Magnesium Oxide | | | hours | 0.1 | 0.1 | 0.1 | 0.0 | 0.0 | 0.0 | 0.0 |
| | Composition 2 | | | | | | | | | | |
| | 10 wt. % Magnesium sulfate | | | | | | | | | | |
| | 60 wt. % Sand | | | | | | | | | | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A solidified composition comprising:
magnesium oxide; and
a salt;
wherein the solidified composition is formed from a slurry, the slurry comprising a first solution, the first solution comprising water, the first solution further comprising one or more actinides, one or more nitrate salts, or both.

2. The solidified composition of claim 1, wherein water is present in the slurry in an amount of about 10 wt. % or more.

3. The solidified composition of claim 1, wherein nitrate salts are present in the slurry, the nitrate salts being present in the slurry in an amount of about 30 wt. % or less.

4. The solidified composition of claim 1, wherein the magnesium oxide is light burned magnesium oxide.

5. The solidified composition of claim 1, wherein the magnesium oxide is dead burned magnesium oxide.

6. The solidified composition of claim 1, wherein the slurry comprises a heat sink additive.

7. The solidified composition of claim 6, wherein the heat sink additive is present in the slurry in an amount of about 1 wt. % or more.

8. A solidified composition comprising:
magnesium oxide, wherein the solidified composition is formed from a slurry, the slurry comprising:
magnesium oxide, the magnesium oxide being present in the slurry in an amount of about 5 wt. % or more;
a salt, the salt being present in the slurry in an amount of about 1 wt. % or more; and
water, the water being present in the slurry in an amount of about 10 wt. % or more;
wherein the solidified composition has a leachate pH from about 7 to about 11.

9. The solidified composition of claim 8, wherein the solidified composition has a leachate pH from about 8 to about 10.

10. The solidified composition of claim 8, wherein the salt is an alkaline earth salt.

11. The solidified composition of claim 8, wherein the salt is a sulfate salt.

12. The solidified composition of claim 8, wherein the magnesium oxide is present in the slurry in an amount of about 10 wt. % or more.

13. The solidified composition of claim 8, wherein the slurry comprises one or more actinides.

14. A solidified composition comprising:
magnesium oxide, wherein the solidified composition is formed from a slurry, the slurry comprising:
light burned magnesium oxide; and
dead burned magnesium oxide, the light burned magnesium oxide and the dead burned magnesium oxide being present in the slurry in a weight ratio from about 1:20 to about 10:1;
wherein the solidified composition comprises magnesium hydroxide and has a density greater than about 0.5 g/mL.

15. The solidified composition of claim 14, wherein the light burned magnesium is present in the slurry in an amount greater than about 5 wt. %.

16. The solidified composition of claim 14, wherein the dead burned magnesium is present in the slurry in an amount greater than about 5 wt. %.

17. The solidified composition of claim 14, wherein the solidified composition has a density greater than about 1 g/mL.

18. The solidified composition of claim 14, wherein the slurry comprises a salt.

19. The solidified composition of claim 18, wherein the salt is an alkaline earth salt.

20. The solidified composition of claim 14, wherein the slurry comprises one or more actinides.
